(19) United States
(12) Patent Application Publication
(10) Pub. No.: US 2010/0078943 A1
(43) Pub. Date: Apr. 1, 2010

(54) Energy Generation Structure

(76) Inventor: Laurie CHETWOOD, London (GB)

Correspondence Address: COOK ALEX LTD, SUITE 2850, 200 WEST ADAMS STREET, CHICAGO, IL, 60606, US

(21) Appl. No.: 12/241,916

(22) Filed: Sep. 30, 2008

(51) Int. Cl. F03D 9/00

(52) U.S. Cl. 290/55

(57) ABSTRACT

An energy generation structure comprising: a wind collector comprising a wind barrier such as a flexible membrane, an aperture through the barrier, and a plurality of supporting elements anchoring the barrier to a supporting body, the wind collector being thereby arranged to funnel wind through the aperture. The structure further comprises at least one wind turbine disposed at the aperture so as to generate energy from wind passing through the aperture.

### FIELD OF THE INVENTION

The present invention relates to the field of renewable energy, specifically the generation of energy from wind.

### BACKGROUND

Wind turbines generate electrical energy from the wind. However, the amount of energy incident in a moving mass of air per unit time (and therefore the power that can be extracted from that air) is known to vary approximately in proportion to the cube of its speed. Therefore wind turbines are very sensitive to wind speed, and it is desirable to achieve and maintain a suitably high wind speed through the turbine.

To contend with this, wind turbines are typically mounted as high above ground as practicably possible, where wind speeds are usually greater and more reliable due to reduced wind sheer. Wind sheer is the interaction between the wind and obstacles in the terrain, analogous to friction. In a typical arrangement as shown schematically in FIG. 1, a wind turbine 2 comprising a generator 4 and a plurality of airfoil blades 6 is mounted on top of a mast or tower 8. A group of such turbines and their towers may be grouped together into a farm.

However, much work goes into surveying the countryside to find reliably windy locations for such wind farms, which involves collecting wind speed data over a number of different locations regarding the number of hours each year the wind spends at different speeds. This is labour intensive when multiplied over many potential sites, and when the survey is completed it will often be found that the percentage of suitable sites is limited. Furthermore, each wind farm takes up a large amount of land that could otherwise be used for agricultural, industrial, residential or recreational purposes.

More recently, some wind farms have been located off-shore. These comprise turbines 2 similar to those of land-based farms, but mounted on towers supported by piles driven into the sea bed. This provides improved energy generation because the wind sheer off shore is much lower than over land, so wind speeds are typically greater. Further, the interface between a large body of water and its adjacent land creates greater winds. Water has a higher heat capacity than the land, so it changes temperature more slowly. This creates a temperature difference between the water and the land, causing hotter air over the hotter region to rise and be replaced by currents of colder air from the colder region, thus resulting in wind. This effect is known as the land-sea breeze. However, the downside to off-shore wind farms is that they are much more difficult to engineer, more costly, and may also provide an obstacle to shipping.

Given the problems above, it would be desirable to find an alternative way of locating wind turbines.

Spanish patent publication no. 8503789 (Alvarez) has disclosed a wind turbine surrounded by a concave screen acting as a funnel to capture wind and direct it towards the turbine. However, Alvarez gives no consideration as to how this structure should be located or anchored within its surroundings.

### SUMMARY

Conventional wisdom has been that wind turbines should be mounted high above the terrain due to the effects of wind sheer. However, the height of a turbine's tower is limited due to structural considerations and cost, and so in fact the potential for exploiting the benefit of height is limited.

Instead, the inventor has recognised the potential for exploiting the properties of the terrain itself, rather than attempting to distance the turbine from the terrain. This can be achieved by mounting a wind capturing structure between two land masses such as to the opposing sides of a gorge or valley. Thus the funnelling effect of the landscape can be exploited to improve generation of energy from the wind, whilst at the same time the funnelling edges of that landscape can advantageously be used to mount or support a wind capturing structure in order to further funnel the wind.

A similar effect can be achieved by mounting the Wind capturing structure to one or more architectural structures such as to a bridge or between two buildings. In the case of a bridge, the wind may be funnelled along the length of the river valley, estuary, gorge or such like that is bridged. In the case of buildings, the wind may be funnelled along the length of a street or between two sky scrapers, etc. At the same time, it is possible to take advantage of the bridge or buildings (which may already exist for their primary, civic purpose) in order to support the wind capturing structure itself.

However, the wind capturing structure disclosed by Alvarez is unlikely to be suitable for large scale applications such as for mounting to land masses, bridges or buildings. An improved structure would therefore be desirable. The inventor has recognised that a flexible membrane would be more suitable for large scale structures.

According to one aspect of the present invention, there is provided an energy generation structure comprising: a wind collector comprising a flexible membrane, an aperture through the flexible membrane, and a plurality of supporting elements anchoring the flexible membrane to a supporting body, the wind collector being thereby arranged to funnel wind striking the flexible membrane through the aperture; and at least one wind turbine disposed at said aperture so as to generate energy from wind passing through the aperture.

In embodiments, the flexible membrane may have an elastic property so as to temporarily stretch under force of said wind.

Said supporting body may comprise a land mass. Said supporting body may comprise an architectural edifice having a primary function other than supporting said flexible membrane. Said architectural edifice may comprise a bridge. Said architectural edifice may comprise a plurality of buildings.

The supporting body may be located substantially by a body of water. Said barrier may be substantially in the shape of a spinnaker sail. Said barrier may be substantially in the shape of a flared tube. Said barrier may be substantially frustroconical in shape.

The structure may comprise a channelling housing disposed at said aperture and surrounding the turbine, arranged to channel the wind funnelled through the aperture over the turbine.

The structure may comprise a plurality of wind turbines disposed at said aperture so as to generate energy from wind passing through the aperture.

The flexible membrane may be a single, continuous sheet.

According to another aspect of the present invention, there is provided an energy generation structure comprising: a wind collector comprising a wind barrier, an aperture through the barrier, a first supporting element anchored to a side of a first land mass portion, and a second supporting element anchored to a substantially opposing side of second land mass portion, the barrier being thereby arranged to funnel wind passing between said opposing sides of the first and second land mass portions through the aperture; and at least one wind turbine disposed at said aperture so as to generate energy from wind passing through the aperture.

According to another aspect of the present invention, there is provided an energy generation structure comprising: a wind collector comprising a wind barrier, an aperture through the barrier, a plurality of supporting elements anchoring the barrier to an architectural edifice having a primary function other than supporting said barrier, the wind collector being thereby arranged to funnel wind through the aperture; and at least one wind turbine disposed at said aperture so as to generate energy from wind passing through the aperture.

According to another aspect of the present invention, there is provided an energy generation structure comprising: a wind collector comprising a wind barrier, an aperture through the barrier, and a plurality of supporting elements anchoring the flexible membrane to a supporting body, the wind collector being thereby arranged to funnel wind striking the flexible membrane through the aperture; at least one wind turbine disposed at said aperture so as to generate energy from wind passing through the aperture; and a channelling housing disposed at said aperture and surrounding the turbine, arranged to channel the wind funnelled through the aperture over the turbine.

According to further aspects of the present invention, there are provided corresponding methods of funnelling wind though a wind collector and using the funnelled wind to drive a turbine.

### BRIEF DESCRIPTION OF THE DRAWINGS

For a better understanding of the present invention and to show how it may be carried into effect, reference will now be made by way of example to the accompanying drawings in which:

FIG. 1 is a schematic representation of part of a conventional wind farm,

FIG. 2 is a schematic diagram illustrating the effects of a constricted airflow,

FIG. 3 is a schematic representation of a wind dam within its surroundings, and

FIG. 4a is a simplified line drawing of a sail for use in a wind dam,

FIG. 4b is an alternative view of the sail of FIG. 4a,

FIG. 4c is another alternative view of the sail of FIG. 4a,

FIG. 4d is another alternative view of the sail of FIG. 4a,

FIG. 5 is a schematic representation of an alternative wind dam,

FIG. 6 is a schematic representation of another alternative wind dam,

FIG. 7 is a schematic representation of a cluster of turbines,

FIG. 8a is a simplified drawing of an alternative sail shape, and

FIG. 8b is another simplified drawing of an alternative sail shape

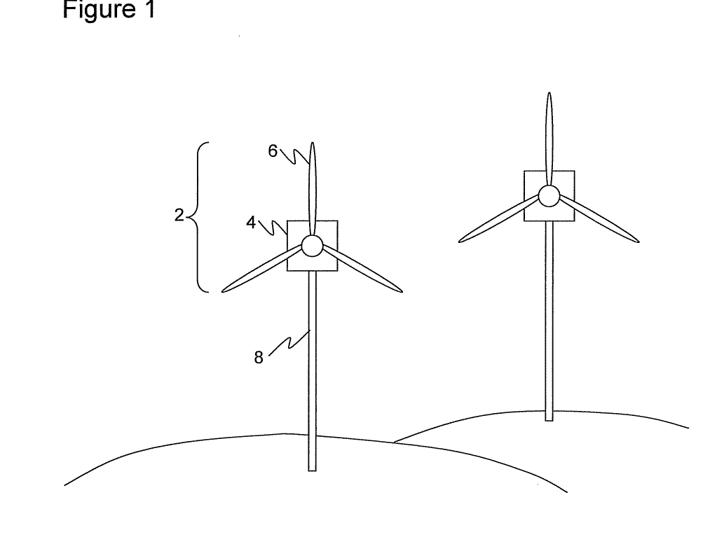

### DETAILED DESCRIPTION OF PREFERRED EMBODIMENTS

According to a preferred embodiment, the present invention provides a “wind dam” capable of harnessing relatively minimal wind volumes at low prevailing speeds to generate power via a turbine. The wind dam is preferably in the form of a sail-like barrier tethered between two land masses strategically located to harness the prevailing wind, such as in a gorge or narrow valley. The funnelling effect of the gorge or valley concentrates the mass of air, which is captured by the sail and diverted through a turbine, generating electricity. The wind dam may alternatively be tethered to an architectural edifice such as a bridge or between two buildings.

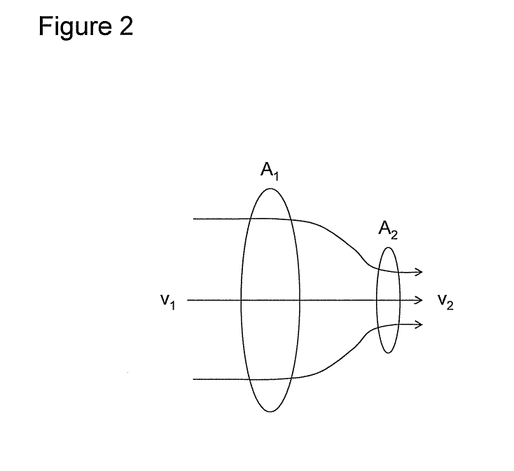

With reference to the schematic diagram of FIG. 2, consider a mass of air flowing through a cross-sectional area A₁. In an infinitesimal time dt, this traces out a volume v₁A₁dt, which has a mass dm=ρv₁A₁dt where ρ is the density. Therefore the rate of flow of mass is β v₁A₁. If the same mass of air is then forced through a smaller area A₂, the rate of flow of mass becomes ρ v₂A₂ assuming the density remains approximately constant. Therefore by the conservation of mass, ρ v₁A₁=ρ v₂A₂ (the continuity equation) and so the speed must increase by a factor A₁/A₂. That is:

$${v}_{2} = \frac{{A}_{1}}{{A}_{2}} {v}_{1}$$

By a rough approximation, this effect can be considered to apply to the speed of wind incident on an opening of a gorge, valley or such like, assuming that relatively little wind escapes the opening and there is relatively little compression of the air (i.e. the density ρ is approximately constant). Therefore by erecting a wind turbine structure in a gorge or valley, etc. then a higher speed v₂ can be achieved through the turbine than if placed directly in the wind prevailing at speed v₁, and thus more electrical energy can be generated (particularly remembering that the amount of wind energy incident on the turbine per unit time is proportional to the cube of the wind speed). Thus the funnelling effect of the gorge can be advantageously exploited to help generate energy from the wind.

As mentioned, land-sea breezes tend to create greater winds than inland. The same effect can also occur by other large bodies of water such as lakes, which may be referred to as land-lake breezes. Therefore preferably (but not necessarily) the wind turbine structure is erected in the mouth of a gorge, valley or fjord opening onto a large body of water such as a lake or sea.

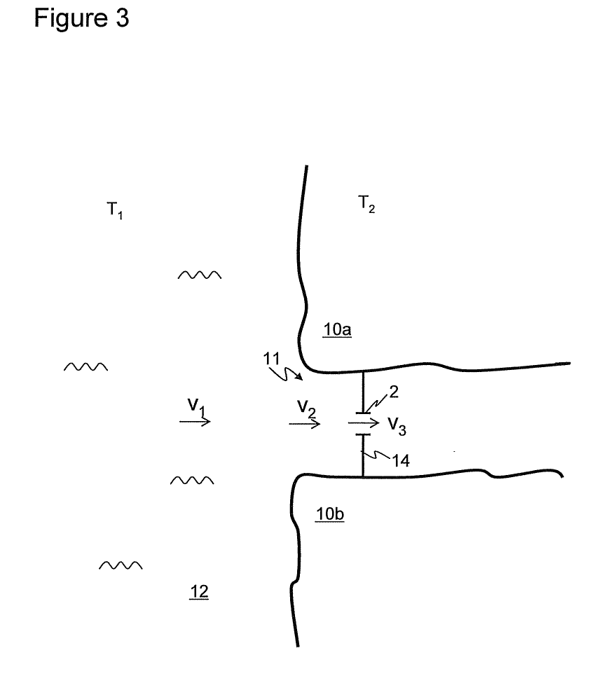

A bird's eye view of a particularly preferred arrangement is shown schematically in FIG. 3. Here, a land mass 10 is substantially adjacent to a large lake 12. The land mass 10 has two portions 10a and 10b defining a gorge 11 between them, with two respective opposing faces. The length of the gorge 11 will ideally be at roughly a normal to the lake's shoreline. The lake 12, land mass 10 and gorge 11 are preferably naturally occurring features of the landscape, although in principle one or more of these features could be man-made or exaggerated artificially.

Say for example it is some time during the day. The sun has been shining on both the land 10 and lake 12 for a number hours, providing heat energy to them both. However, the lake 12 will typically have a higher heat capacity than the land 10, and so the land 10 will experience a greater increase in temperature than the lake 12 for a given input of heat energy (Referring to FIG. 3, T₂>T₁). This in turn means that the air over the land 10 will become hotter than that over the lake 12, and therefore less dense. The less-dense hot air over the land 10 will then rise (i.e. in the direction out of the page in FIG. 3), creating a lower pressure region which pulls cold air inland from the colder, denser region over the lake 12. Thus a land-lake breeze is generated in the direction from the lake 12 to the land, marked v₁ in FIG. 3. During the night, the land cools faster than the sea and so the direction of the lake-land breeze is reversed.

Thus if the gorge opens onto the lake, ideally opening out at roughly a normal to the lake's main shoreline, then the land-lake breezes generated by the interface between the lake 12 and land 10 will flow through the gorge 11. The land-lake breeze may of course be supplemented by winds generated by other weather systems generally present in the wider region. All or any such winds can be harnessed to generate energy.

At least some of the wind across the shores of the land mass portions 10a and 10b bounding the gorge 11 will be funnelled through the gorge. According to the reasoning given above, this means the wind flowing in the gorge 11 will travel at a speed v₂ which is about a factor A₁/A₂ greater than the prevailing wind speed v₁ (or at least that order of magnitude), where A₂ is the area of the gorge's opening and A₁ is the area from which the incident wind is funnelled.

Thus the wind can be harvested by locating a wind turbine 2 within the gorge, preferably with its axis approximately aligned with the opening. Furthermore, the location of a turbine 2 in the gorge 11 provides a unique opportunity for further funnelling the wind flowing in the gorge 11 through an even smaller area in order to increase its speed even further. That is, the same opposing faces of the gorge 11 that facilitate the funnelling of wind can themselves also be used to support a large wind-collecting barrier 14. The barrier 14 is constructed so as to be anchored to the sides of the gorge 11 by any suitable supporting members such as cables, lines, pins, piles, braces, girders, struts, joists, columns, etc.; and has an aperture of area A₃ made through the barrier 14. Thus the wind travelling at speed v₂ over area A₂ in the gorge 11 is forced through an even smaller area A₃. According to the reasoning given above, the speed V₃ of the air travelling through the turbine then becomes approximately:

$${v}_{3} = \frac{{A}_{2}}{{A}_{3}} {v}_{2} = \frac{{A}_{1}}{{A}_{3}} {v}_{1}$$

Thus by using a gorge or such like to support a wind-catching barrier structure, then the wind from a relatively large area can advantageously be funnelled through a much smaller area in order to increase the speed of the wind through the turbine and therefore increase the power generated (again remembering particularly that the amount of wind energy incident on the turbine per unit time is proportional to the cube of the wind speed).

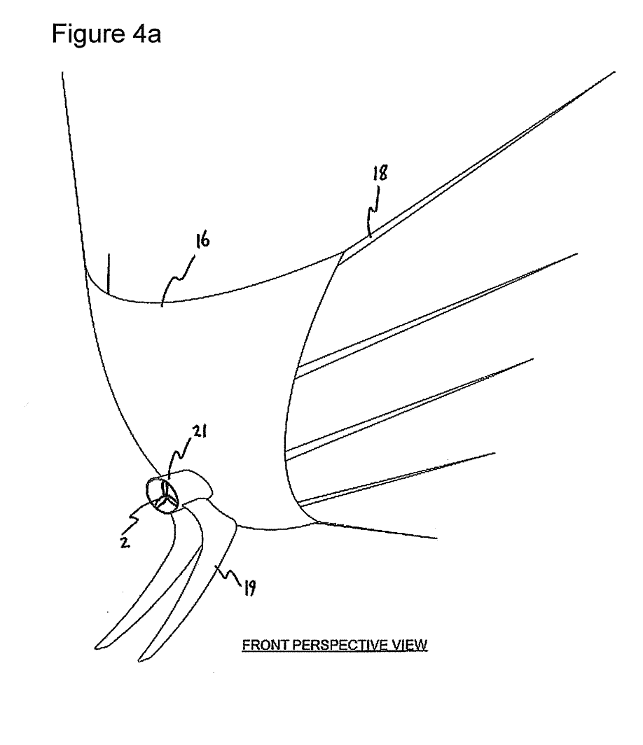

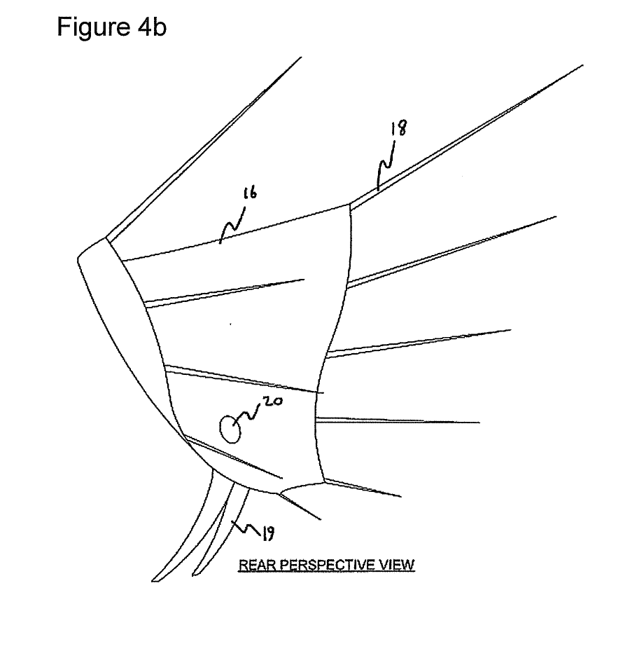

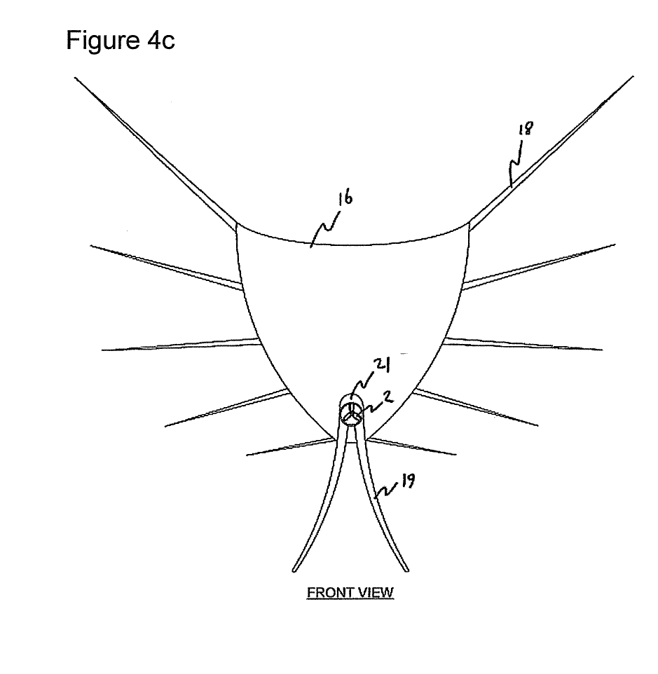

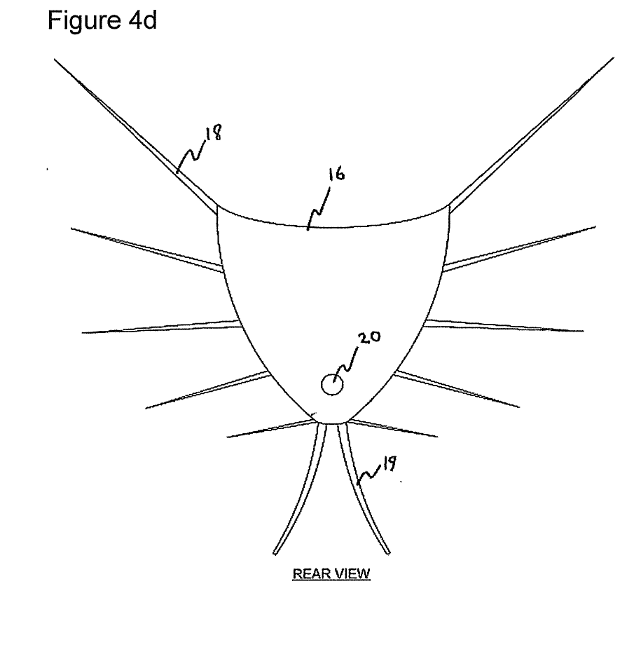

As illustrated in FIGS. 4a, 4b, 4c and 4d, the applicant believes that a structure shaped like a spinnaker sail will be particularly effective in harnessing the wind energy. A front perspective view of such a structure is shown in FIG. 4a, a rear perspective is shown in FIG. 4b, a front view of the sail is shown in FIG. 4c and a rear view of the sail is shown in FIG. 4d.

In this example, the barrier 14 comprises a sail-like portion 16, a hole or other aperture 20 through the sail-like portion 16, and a plurality of supporting lines 18. The sail-like portion 16 is shaped like an upturned spinnaker sail, i.e. in a cupped triangular shape with two corners at the top and one corner at the bottom. Each of the supporting lines 18 has an end attached to a side of the sail and its other end anchored to the surrounding landscape. Preferably, each of a plurality of first supporting lines 18 are attached to one side of the sail 16 and anchored to a side of the first land mass portion 10a of the gorge 11, and each of a plurality of second supporting lines 18 are attached to another side of the sail 16 and anchored to a side of the second land mass portion 10b of the gorge 11. Preferably a respective supporting line 18 is attached from each of the top corners of the sail 16 and anchored to a respective side of the gorge 11, and one or more other supporting lines 18 anchor the bottom corner of the sail either to the bottom of the gorge 11 or to the two sides. Thus the sail 16 is suspended by the supporting lines 18 in the gorge.

In a preferred embodiment, the sail comprises a flexible membrane, which could be fashioned for example from Kevlar, PVC (polyvinyl chloride) coated polyester, or PTFE (Polytetrafluoroethylene) coated glass fibre cloth. The supporting lines 18 may be flexible metal cables. This allows the sail 16 to billow or balloon out when windy, and straighten or become limp when not. The flexible option is advantageous because it is better suited to large scale applications and also may fit many situations.

In a particularly preferred embodiment, the flexible membrane may be of a material having an elastic property so that it will temporarily flex or stretch in relation to the force of the wind blowing against it, and straighten out again when the wind dies down, but not permanently deform nor remain rigid. For example, rubber or an artificial rubber-like material could be used. This may advantageously protect against the wind load on the structure created when the wind gusts.

The flexible membrane is preferably of a single, continuous sheet of material (i.e. not in panels) for improved structural integrity.

The sail 16 may be supported by a solid or flexible frame around its perimeter, by solid ribs passing along it, or by ringlets or similar embedded in the sail to which the cables 18 can be attached.

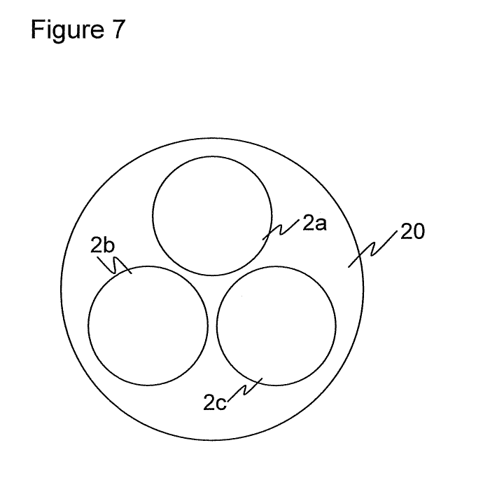

As mentioned, an aperture 20 is formed through the sail 16. As in the illustrated example, the aperture 20 is not necessarily located at the exact centre of the sail 16, but is substantially located in a middle region of the sail 16 at a focal point for collecting wind, so that wind will be funnelled though the aperture 20. The turbine 20 is disposed at the aperture 20, with its axis facing substantially along the direction of the gorge's opening, so that the wind funnelled through the aperture 20 will be directed through the turbine 2. In embodiments, a plurality of turbines could be arranged in parallel at the aperture 20, i.e. beside each other. For example, three turbines 2a, 2b and 2c could be arranged side-by-side in an aperture 20 in the barrier 16, as illustrated schematically in FIG. 7 (or each turbine could be disposed in its own respective aperture).

The turbine 2 may be supported by one or more rigid legs 19, e.g. of metal, founded in the base of the gorge or in its sides but close to the gorge's base. Preferably, a tube 21 or other channelling housing may surround the turbine 2 and be disposed at the aperture 20 so as to channel the funnelled wind over the turbine. The axis of the tube 21 is substantially along the axis of the turbine 2 and the tube 21 is open at the rear. It may be noted that such an element is not present in Alvarez.

The turbine's blade diameter may be around four meters, with the aperture 20 of a similar diameter.

Note that the supporting structure (e.g. 18) may have two purposes: that is, to tether the membrane 16 and also to at least partially support the turbine 2 (optionally in addition to the one or more legs 19 mentioned above).

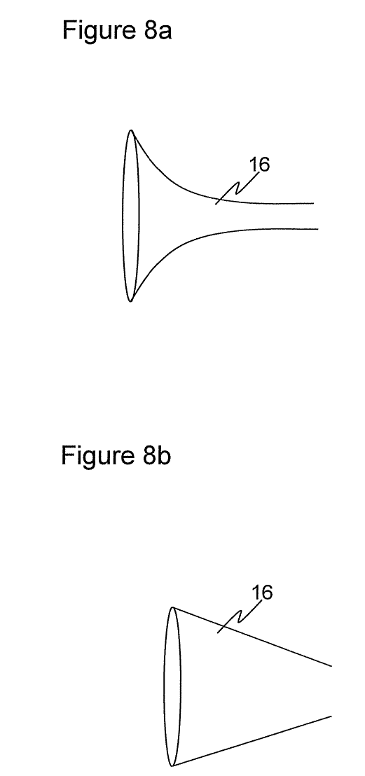

Other shapes could also be used for the barrier 14. In alternative embodiments for example, the barrier 14 could shaped as a flared tube with an arcuate radius like the mouth of a trumpet or similar (e.g. FIG. 8a), the barrier 14 could be frustroconical in shape like a wind sock (e.g. FIG. 8b), or the barrier 14 could be a pyramidal funnel as in the Alvarez reference cited above or other similar funnel formed from polygonal panels. More generally, the wind-catching barrier 14 can be anything presenting an area to the wind and having an aperture smaller that that area, although preferably the barrier 14 will be of a tapered shape such as a sail, trumpet, windsock or polygonal-panelled funnel to direct air through the aperture. If required, a suitable shape for a given situation can be found empirically by FEM (finite element modelling) computer modelling or testing of scale models in a wind tunnel. The particular shape may be designed to the particular situation in question. The barrier 14 can be anchored to the surrounding landscape by any suitable supporting members as will be apparent to a person skilled in the art of civil engineering.

Note also that if the barrier 14 is being located by a body of water in order to take advantage of land-sea or land-lake breezes, then the barrier can be oriented in either direction along the gorge 11 (or such like) since the breezes are cyclical over the period of a day, blowing in land during the daytime and outward during the night.

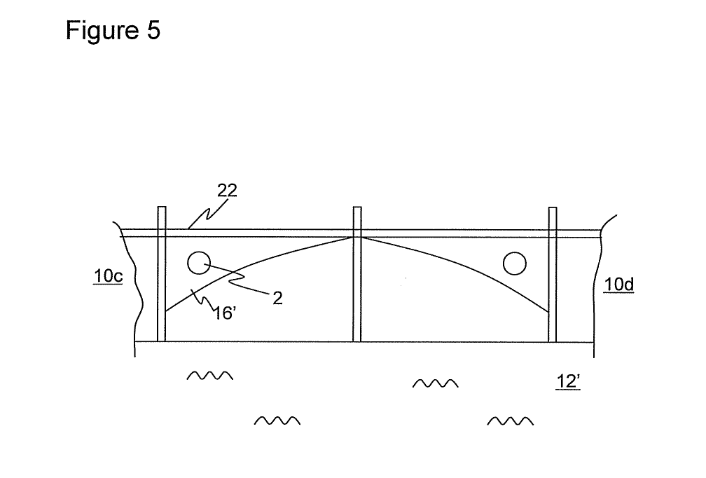

An alternative embodiment is now described in relation to FIG. 5. Many architectural edifices exist which have a primary, civic function or purpose. For example, a bridge has a primary function of facilitating passage of people or vehicles across a river, gorge, estuary or such like. However, according to embodiments of the present invention, it is also possible to endow such edifices with a secondary function of supporting a wind capturing structure of the type disclosed herein. FIG. 5 shows an example of a bridge 22 bridging between two land mass portions 10c and 10d over a river 12′. In the example shown, one or more flexible membranes 16′ are each suspended between the underside of the bridge 22 and a respective one of the bridge's legs. Each membrane 16′ has an aperture therethrough at which is disposed a respective turbine 2. The bridge 22 thus acts as a supporting body, as an alternative to the land mass 10, for supporting the wind capturing structure. In this case, the river valley, estuary or gorge may still perform the function of funnelling the wind into the structure, and in embodiments the structure may particularly benefit from being mounted on a bridge close to an opening onto a large body of water such as a lake or sea in order to take advantage of the breezes they generate. Preferably the membrane 16′ is of an elastic, flexible material to reduce wind load on the bridge during gusts.

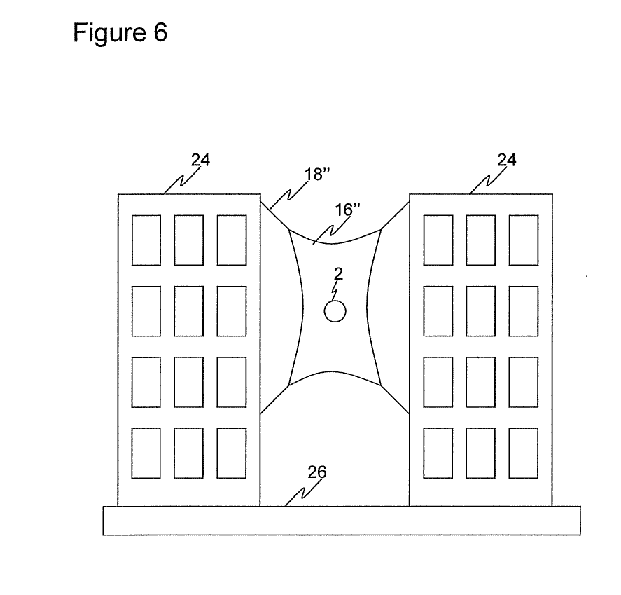

Another example is shown in FIG. 6. Here the architectural edifice is a pair of buildings 24, whose primary function is containing people. A flexible membrane 16″ having an aperture therethrough is suspended from the sides of the two buildings 26 by means of flexible cables 18″. Thus the buildings 24 along with their foundations and the ground 26 together form a supporting body, again as an alternative to the land mass 10, for supporting the wind capturing structure. In that case, the gap between the buildings 24 or generally along their street may act to funnel the wind into the structure in a similar manner as discussed in relation the gorge 11. Again, preferably the membrane 16″ is of an elastic, flexible material to reduce wind load on the buildings during gusts.

It will be appreciated that the above embodiments are described only by way of example. The scope of the invention is not limited by the described embodiments, but only by the following claims.

1. An energy generation structure comprising:
a wind collector comprising a flexible membrane, an aperture through the flexible membrane, and a plurality of supporting elements anchoring the flexible membrane to a supporting body, the wind collector being thereby arranged to funnel wind striking the flexible membrane through the aperture; and
at least one wind turbine disposed at said aperture so as to generate energy from wind passing through the aperture.

2. The structure of claim 1, wherein the flexible membrane has an elastic property so as to temporarily stretch under force of said wind.

3. The structure of claim 1, wherein said supporting body comprises a land mass.

4. The structure of claim 1, wherein said supporting body comprises an architectural edifice having a primary function other than supporting said flexible membrane.

5. The structure of claim 4, wherein said architectural edifice comprises a bridge.

6. The structure of claim 4, wherein said architectural edifice comprises a plurality of buildings.

7. The structure of claim 1, wherein said supporting body is located substantially by a body of water.

8. The structure of claim 1, wherein said barrier is substantially in the shape of a spinnaker sail.

9. The structure of claim 1, wherein said barrier is substantially in the shape of a flared tube.

10. The structure of claim 1, wherein said barrier is substantially frustroconical in shape.

11. The structure of claim 1, wherein the structure comprises a channelling housing disposed at said aperture and surrounding the turbine, arranged to channel the wind funnelled through the aperture over the turbine.

12. The structure of claim 1, wherein the structure comprises a plurality of wind turbines disposed at said aperture so as to generate energy from wind passing through the aperture.

13. The structure of claim 1, wherein the flexible membrane is a single, continuous sheet.

14. An energy generation structure comprising:
a wind collector comprising a wind barrier, an aperture through the barrier, a first supporting element anchored to a side of a first land mass portion, and a second supporting element anchored to a substantially opposing side of second land mass portion, the barrier being thereby arranged to funnel wind passing between said opposing sides of the first and second land mass portions through the aperture; and
at least one wind turbine disposed at said aperture so as to generate energy from wind passing through the aperture.

15. The structure of claim 14, wherein said barrier has a tapered shape so as to direct said air path through said aperture.

16. The structure of claim 14, wherein said barrier is substantially in the shape of a spinnaker sail.

17. The structure of claim 14, wherein said barrier is substantially in the shape of a flared tube.

18. The structure of claim 14, wherein said barrier is substantially frustroconical in shape.

19. The structure of claim 18, wherein said sides are opposing sides of one of a gorge, a valley, and a fjord.

20. The structure of claim 19, wherein said gorge, valley or fjord opens onto a body of water.

21. The structure of claim 20, wherein said body of water comprises one of a sea and a lake.

22. The structure of claim 14, wherein the structure comprises a channelling housing disposed at said aperture and surrounding the turbine, arranged to channel the wind funnelled through the aperture over the turbine.

23. The structure of claim 14, wherein the structure comprises a plurality of wind turbines disposed at said aperture so as to generate energy from wind passing through the aperture.

24. An energy generation structure comprising:
a wind collector comprising a wind barrier, an aperture through the barrier, a plurality of supporting elements anchoring the barrier to an architectural edifice having a primary function other than supporting said barrier, the wind collector being thereby arranged to funnel wind through the aperture; and
at least one wind turbine disposed at said aperture so as to generate energy from wind passing through the aperture.

26. The structure of claim 24, wherein said architectural edifice comprises a bridge.

27. The structure of claim 24, wherein said architectural edifice comprises one or more buildings.

28. The structure of claim 24, wherein said barrier has a tapered shape so as to direct said air path through said aperture.

29. The structure of claim 24, wherein said barrier is substantially in the shape of a spinnaker sail.

30. The structure of claim 24, wherein said barrier is substantially in the shape of a flared tube.

31. The structure of claim 24, wherein said barrier is substantially frustroconical in shape.

32. The structure of claim 24, wherein the structure comprises a channelling housing disposed at said aperture and surrounding the turbine, arranged to channel the wind funnelled through the aperture over the turbine.

33. The structure of claim 24, wherein the structure comprises a plurality of wind turbines disposed at said aperture so as to generate energy from wind passing through the aperture.

34. An energy generation structure comprising:
a wind collector comprising a wind barrier, an aperture through the barrier, and a plurality of supporting elements anchoring the flexible membrane to a supporting body, the wind collector being thereby arranged to funnel wind striking the flexible membrane through the aperture;
at least one wind turbine disposed at said aperture so as to generate energy from wind passing through the aperture; and
a channelling housing disposed at said aperture and surrounding the turbine, arranged to channel the wind funnelled through the aperture over the turbine.
